(19) United States
(12) Patent Application Publication
(10) Pub. No.: US 2015/0103057 A1
(43) Pub. Date: Apr. 16, 2015

(54) TOUCH PEN WITH SUPPORT FUNCTION

(71) Applicants: Fu Tai Hua Industry (Shenzhen) Co., Ltd., Shenzhen (CN); Hon Hai Precision Industry Co., Ltd., New Taipei (TW)

(72) Inventor: QIAN LEI, Shenzhen (CN)

(21) Appl. No.: 14/508,550

(22) Filed: Oct. 7, 2014

(30) Foreign Application Priority Data
Oct. 11, 2013 (CN) 201310472160.1

(51) Int. Cl. G06F 3/0354

(52) U.S. Cl. CPC G06F 3/03545
USPC 345/179

(57) ABSTRACT

A touch pen also functioning as a support includes a first rod, a second rod, and a positioning rod. The second rod has a first end portion pivoting on a first end portion of the first rod and a second contact surface facing a first contact surface of the first rod. One of the first contact surface and the second contact surface includes a number of positioning portions. The positioning rod has a first end portion pivoting relative to the other one of the first contact surface and the second contact surface and away from the first end portion of the first rod. The positioning rod further has a second end portion configured to be engaged with one of the positioning portions to form an angle between the first rod and the second rod which transforms the touch pen into a supporting structure to support an electronic device.

### CROSS-REFERENCE TO RELATED APPLICATIONS

This application claims priority to Chinese Patent Application No. 201310472160.1 filed on Oct. 11, 2013, the contents of which are incorporated by reference herein.

### FIELD

The subject matter herein generally relates to multifunction touch pens.

### BACKGROUND

A touch pen is usually used for touching or writing on an electronic device. Supporting frames or supporting bases are usually used for supporting the electronic device when the electronic device is in use. Users need to carry both items along with the electronic device.

### BRIEF DESCRIPTION OF THE DRAWINGS

Implementations of the present disclosure will now be described, by way of example only, with reference to the attached figures.

FIG. 1 is an isometric view showing a touch pen in a folded state.

FIG. 2 is an exploded view of the touch pen of FIG. 1.

FIG. 3 is an isometric view showing the touch pen of FIG. 1 in an open state.

FIG. 4 is another isometric view showing the touch pen of FIG. 1 in an open state.

FIG. 5 is an isometric view showing the touch pen of FIG. 1 in use.

FIG. 6 is an isometric view similar to FIG. 5, but viewing the touch pen from a different angle.

FIG. 7 is an isometric view showing the touch pen of FIG. 5 not in use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Definitions that apply throughout this disclosure will now be presented.

The term “comprising” means “including, but not necessarily limited to”; it specifically indicates open-ended inclusion or membership in a so-described combination, group, series and the like. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder.

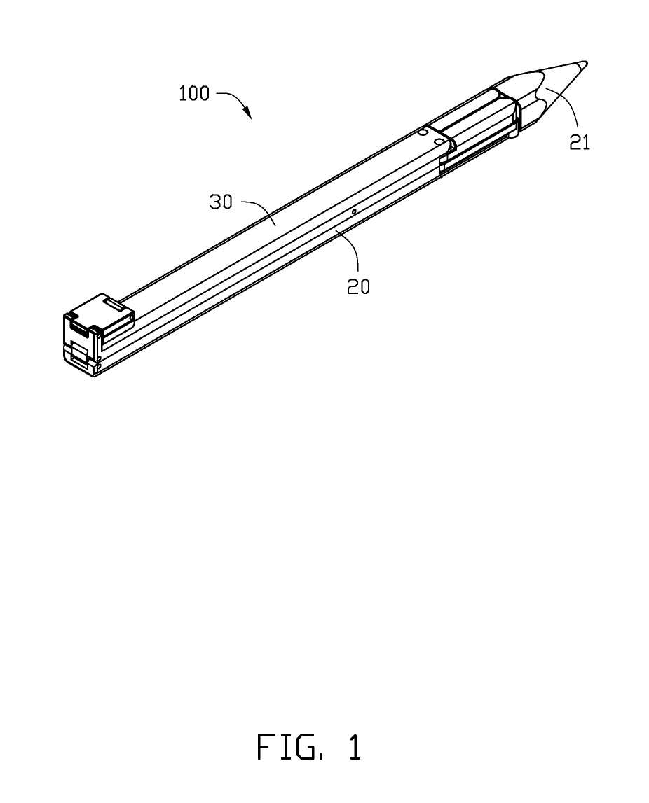

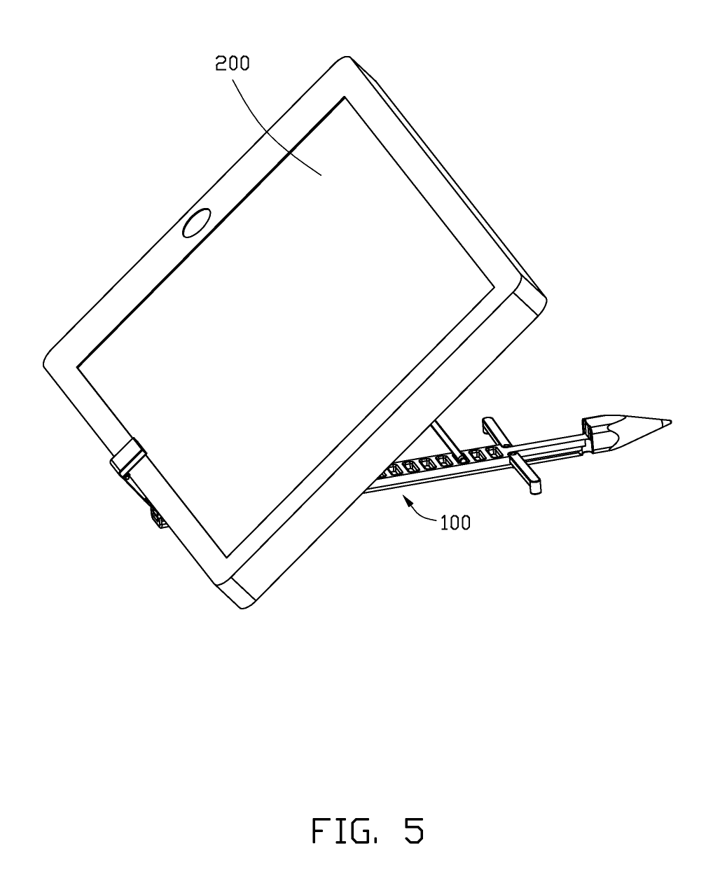

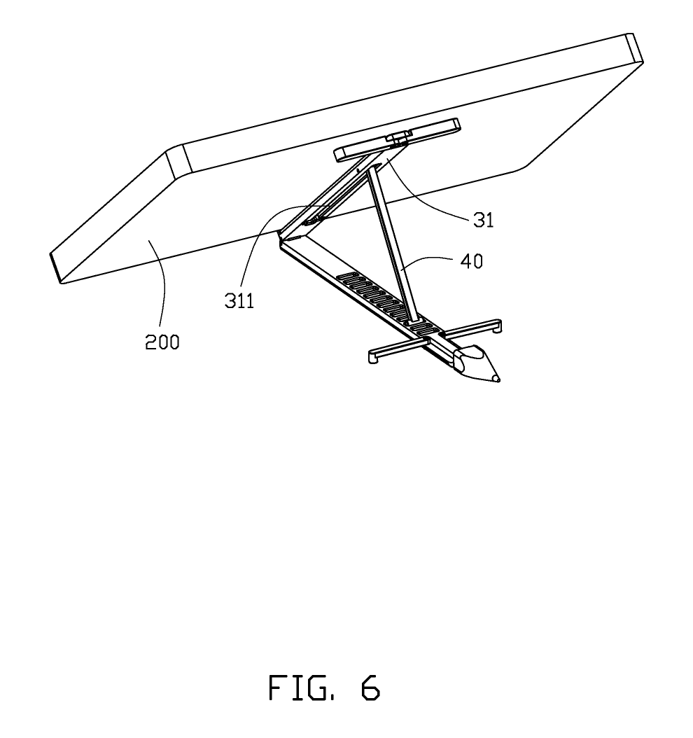

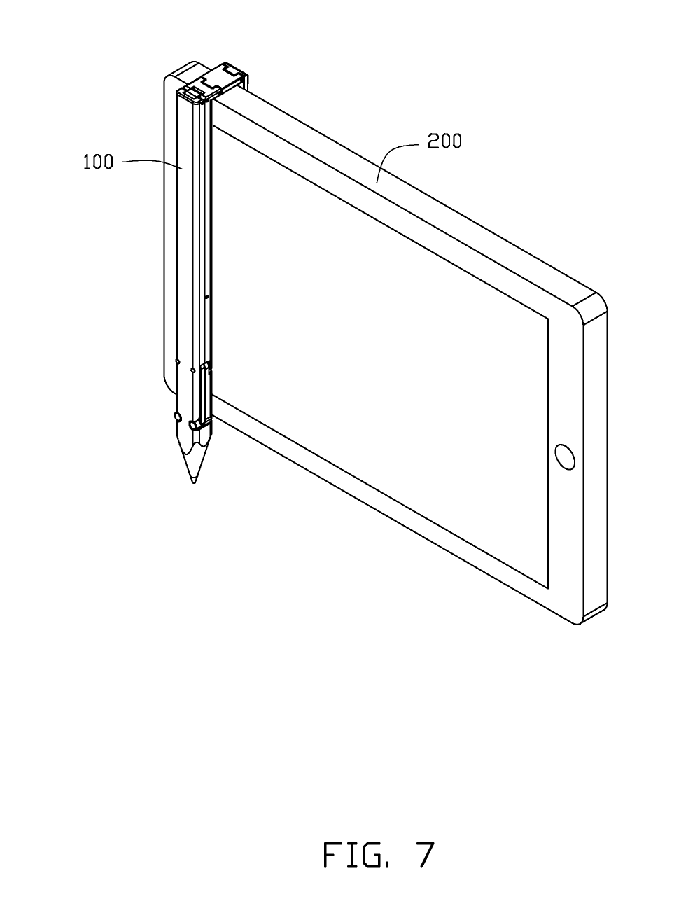

FIG. 1 is an isometric view showing a touch pen 100 in a folded state. When folded, the touch pen 100 can be used as an input device for an electronic device 200 (as shown in FIG. 5). The touch pen 100 also can be clipped or hooked to the electronic device 200 (as shown in FIG. 7) when not in use, or can be unfolded and be used for supporting the electronic device 200 (as shown in FIGS. 5 and 6).

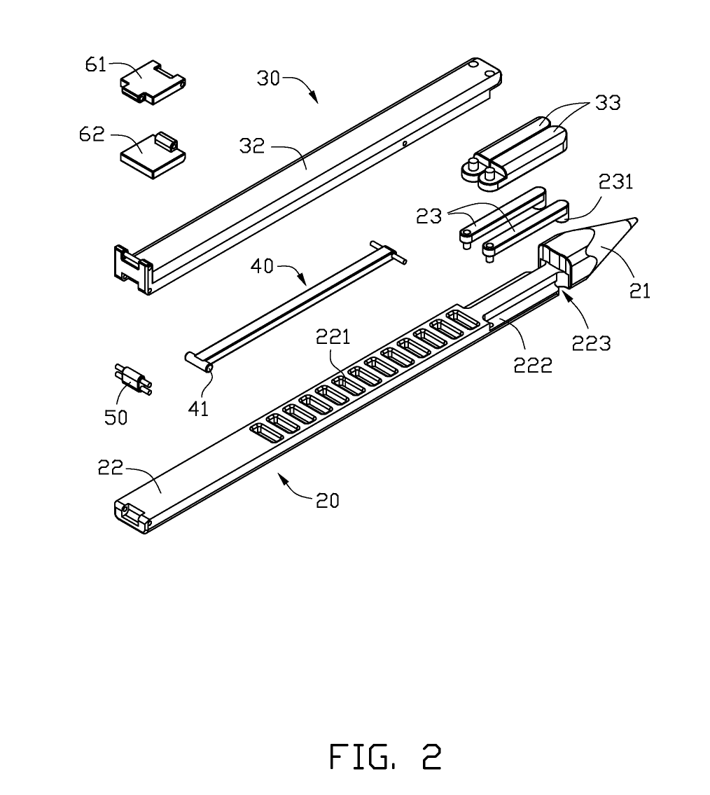

FIG. 2 illustrates that the touch pen 100 includes a first rod 20, a second rod 30, and a pen tip 21. In at least one embodiment, the second rod 30 includes a first end portion pivoting on a first end portion of the first rod 20 via a rotation shaft 50, and the pen tip 21 extends from a second end portion of the first rod 20. The pen tip 21 can touch and create input for the electronic device 200. In at least one embodiment, the pen tip 21 can be made of conductive rubber.

The first rod 20 includes a first contact surface 22 and the second rod 30 includes a second contact surface 31 (as shown in FIG. 6) facing the first contact surface 22. One of the first contact surface 22 and the second contact surface 31 includes a number of positioning portions 221.

The touch pen 100 further includes a positioning rod 40, which includes a first end portion pivoting on the other one of the first contact surface 22 and the second contact surface 31, and is away from the first end portion of the first rod 20. In the illustrated embodiment, the positioning portions 221 are arranged on the first contact surface 22, and the positioning rod 40 pivots on the second contact surface 31.

In at least one embodiment, the other one of the first contact surface 22 and the second contact surface 31 defines a groove 311 (as shown in FIG. 6) configured to receive the positioning rod 40. In the illustrated embodiment, the groove 311 is defined on the second contact surface 31.

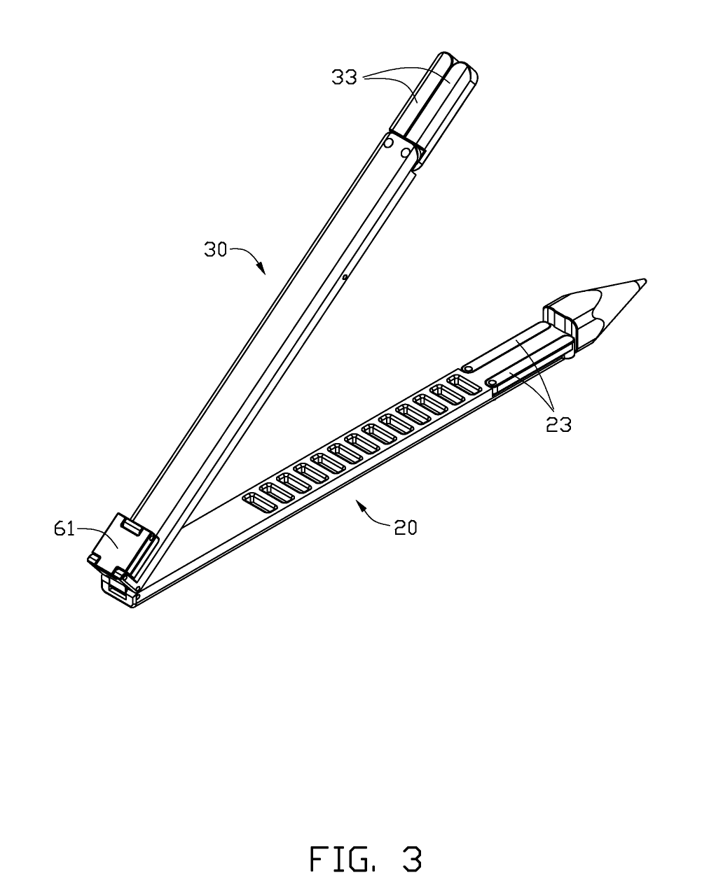

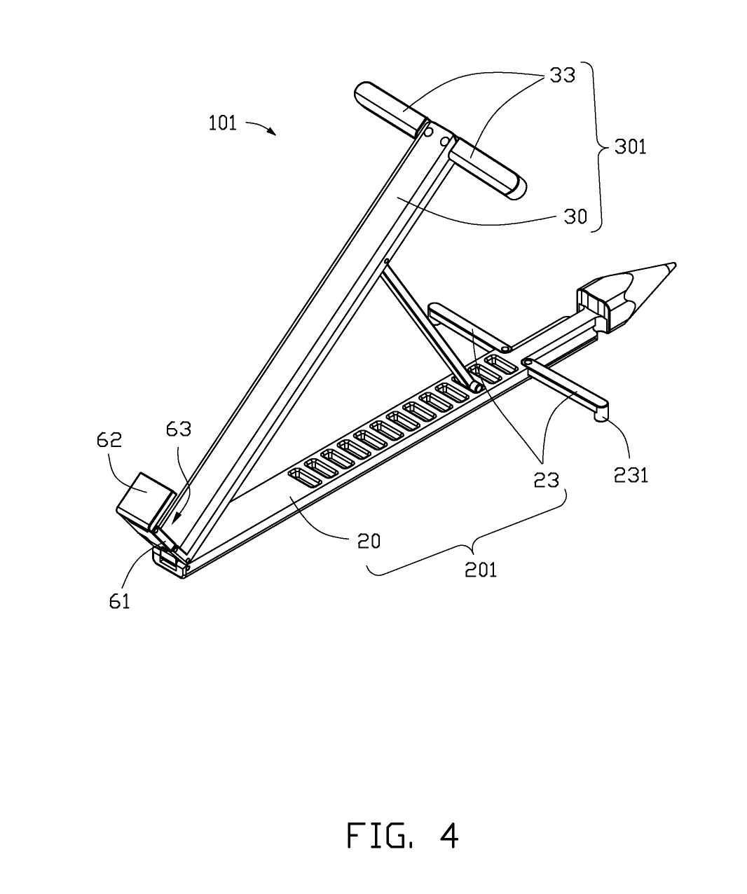

Referring to FIGS. 3 and 4, when the first rod 20 and the second rod 30 are unfolded, the positioning rod 40 can be rotated relative to the other one of the first contact surface 22 and the second contact surface 31. A second end portion of the positioning rod 40 can be engaged with one of the positioning portions 221, to form an angle between the first rod 20 and the second rod 30 which transforms the touch pen 100 into a supporting structure 101 to support the electronic device 200.

In the illustrated embodiment, each positioning portion 221 is formed as a recessed portion on the first contact surface 22. A convex bar 41 extends from the second end portion of the positioning rod 40, and can fit into one of the positioning portions 221. The angle formed between the first rod 20 and the second rod 30 can be adjusted by the engagement of the second end portion of the positioning rod 40 into different positioning portions 221.

Referring to FIGS. 2-4, the touch pen 100 further includes a pair of first supporting frames 23 pivoting symmetrically on two sides of the first rod 20 and away from the first end portion of the first rod 20. The first supporting frames 23 are able to be rotated relative to the first rod 20 to render the first rod 20 and the first supporting frames 23 into a first claw structure 201, to provide the supporting structure 101 with stability when standing on a supporting surface (not shown).

In at least one embodiment, a claw 231 vertically extends from a free end portion of each of the first supporting frames 23. In the illustrated embodiment, a free end portion of each claw 231 is substantially flush with an external surface of the first rod 20 opposite to the first contact surface 22. The free end portions of the claws 231 and the external surface of the first rod 20 cooperate to form a supporting plane, to provide the supporting structure 101 with stability when standing on the supporting surface.

In the illustrated embodiment, the first rod 20 defines a pair of concave parts 222 which are symmetrical about the first contact surface 22 and correspond to the first supporting frames 23. A notch 223 is defined at one end of each of the concave parts 222. When folded, as shown in FIG. 3, the first supporting frames 23 can be received in the concave parts 222, and the claws 231 can be received in the notches 223. Thus, the first supporting frames 23 occupy very little space and make the touch pen 100 convenient to carry.

The touch pen 100 further includes a pair of second supporting frames 33 pivoting symmetrically on two sides of a second end portion of the second rod 30. The second supporting frames 33 are able to be rotated relative to the second rod 30 to transform the second rod 30 and the second supporting frames 33 into a second claw structure 301, to add stability to the electronic device 200 when resting on the supporting structure 101.

In the illustrated embodiment, an external surface of each second supporting frame 33 is substantially flush with an external surface 32 of the second rod 30 opposite to the second contact surface 31. The external surfaces of the second supporting frames 33 and the external surface of the second rod 30 cooperate to form a supporting plane adding stability to the electronic device 200 when resting on the supporting structure 101.

When folded, as shown in FIG. 3, the second supporting frames 33 can be arranged along a longitudinal direction of the second rod 30, and take up a less space and be convenient to carry.

Referring to FIGS. 2-4, the touch pen 100 further includes a first stopper block 61 having a first end portion pivoting on the first end portion of the second rod 30. The first stopper block 61 is able to be rotated relative to the second rod 30 and is configured to provide a resistant platform against a bottom end portion of the electronic device 200 when the electronic device 200 is resting on the supporting structure 101.

In the illustrated embodiment, when the first end portion of the first stopper block 61 binds against the external surface of the second rod 30, the first stopper block 61 cannot rotate further, therefore the range of rotation of the first stopper block 61 is limited.

The touch pen 100 further includes a second stopper block 62 having a first end portion pivoting on a second end portion of the first stopper block 61. The second stopper block 62 is able to be rotated relative to the first stopper block 61 to form a gap 63 between the second stopper block 62 and the second rod 30. In the illustrated embodiment, when the first end portion of the second stopper block 62 binds against the second end portion of the first stopper block 61, the second stopper block 62 cannot rotate further, therefore the range of rotation of the second stopper block 62 is limited.

In the illustrated embodiment, the gap 63 is configured to receive an end portion of the electronic device 200, and stop the electronic device 200 from sliding off the supporting structure 101.

When the touch pen 100 is not in use, the touch pen 100 can be folded as shown in FIG. 7, and the gap 63 enables the touch pen 100 to be hooked or clipped to one edge of the electronic device 200, making the touch pen 100 portable and convenient to carry with the electronic device 200.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size, and arrangement of parts within the principles of the present disclosure, up to and including the full extent established by the broad general meaning of the terms used in the claims.

What is claimed is:

1. A touch pen comprising:
a first rod having a first contact surface; and
a second rod having a first end portion pivoting on a first end portion of the first rod and a second contact surface facing the first contact surface, wherein one of the first contact surface and the second contact surface includes a plurality of positioning portions; and
a positioning rod having a first end portion pivoting relative to one of the first contact surface and the second contact surface and away from the first end portion of the first rod, and a second end portion configured to be engaged with one of the positioning portions to form an angle between the first rod and the second rod which transforms the touch pen into a supporting structure to support an electronic device.

2. The touch pen as described in claim 1, further comprising a pen tip extending from a second end portion of the first rod.

3. The touch pen as described in claim 1, further comprising a pair of first supporting frames pivoting symmetrically on two sides of the first rod and away from the first end portion of the first rod, wherein the first supporting frames are able to be rotated relative to the first rod to render the first rod and the first supporting frames into a first claw structure, to provide the supporting structure with stability when standing on a supporting surface.

4. The touch pen as described in claim 3, wherein the first rod defines a pair of concave parts which are symmetrical about the first contact surface and correspond to the first supporting frames, wherein the concave parts are configured to receive the first supporting frames when the first supporting frames are folded toward the first rod.

5. The touch pen as described in claim 4, wherein a claw vertically extends from a free end portion of each of the first supporting frames, the first rod further defines a notch at one end of each of the concave parts, the notches is configured to receive the claws when the first supporting frames are folded toward the first rod.

6. The touch pen as described in claim 5, wherein a free end portion of each claw is flush with an external surface of the first rod opposite to the first contact surface.

7. The touch pen as described in claim 1, further comprising a pair of second supporting frames pivoting symmetrically on two sides of a second end portion of the second rod, wherein the second supporting frames are able to be rotated relative to the second rod to transform the second rod and the second supporting frames into a second claw structure, to add stability to the electronic device when resting on the supporting structure.

8. The touch pen as described in claim 7, wherein an external surface of each second supporting frame is flush with an external surface of the second rod opposite to the second contact surface.

9. The touch pen as described in claim 1, further comprising a first stopper block having a first end portion pivoting on the first end portion of the second rod, wherein the first stopper block is able to be rotated relative to the second rod and is configured to provide a resistant platform against a bottom end portion of the electronic device when the electronic device rests on the supporting structure.

10. The touch pen as described in claim 9, further comprising a second stopper block having a first end portion pivoting on a second end portion of the first stopper block, wherein the second stopper block is able to be rotated relative to the first stopper block to form a gap between the second stopper block and the second rod, wherein the gap is configured to receive an end portion of the electronic device, and stop the electronic device from sliding down from the supporting structure.

11. The touch pen as described in claim 1, wherein each positioning portion is formed as a recessed portion on one of the first contact surface and the second contact surface.

12. The touch pen as described in claim 11, wherein a convex bar extends from the second end portion of the positioning rod, and is configured to fit into one of the positioning portions.

13. The touch pen as described in claim 1, wherein the other one of the first contact surface and the second contact surface defines a groove configured to receive the positioning rod.
